(19) United States
(12) Patent Application Publication
(10) Pub. No.: US 2019/0202156 A1
(43) Pub. Date: Jul. 4, 2019

(54) METHODS FOR CONTROLLING A TIRE BLANK TURN-UP PROCESS

(71) Applicant: Compagnie Generale Des Etablissements Michelin, Clermont-Ferranc (FR)

(72) Inventors: Michael Massoptier-David, Clermont-Ferrand (FR); Patrice Monnereau, Clermont-Ferrand (FR)

(21) Appl. No.: 16/303,255

(22) PCT Filed: May 22, 2017
(86) PCT No.: PCT/FR2017/051249

§ 371 Date: Nov. 20, 2018

(30) Foreign Application Priority Data
May 20, 2016 (FR) 1654515
Dec. 22, 2016 (FR) 1663236

(51) Int. Cl. B29D 30/32; B29D 30/36

(52) U.S. Cl. CPC B29D 30/32; B29D 2030/3264; B29D 30/36

(57) ABSTRACT

In this method for turning up the plies of a green tire, longitudinal and radial movements, with reference to a main axis (8) of the green tyre (3), of ply-turning arms (20) are brought about independently of one another in order to apply a rubber element to at least one sidewall (5) of the green tire (3). The radial movement of the arms is controlled by means of a speed setpoint.

### CROSS-REFERENCE TO RELATED APPLICATION

The present application claims priority to PCT International Patent Application Serial No. PCT/FR2017/051249, filed May 22, 2017, entitled “METHODS FOR CONTROLLING A TYRE BLANK TURNOUP PROCESS,” which claims the benefit of FR Patent Application Serial No. 1654515, filed May 20, 2016 and FR Patent Application Serial No. 16663236, filed Dec. 22, 2016.

### BACKGROUND OF THE INVENTION

### 1. Field of the Invention

The invention relates to the turning up of the plies of green tires.

### 2. Related Art

The manufacture of a green tire comprises a ply-turning step which consists in applying a layer of raw rubber to the sidewalls of a green tire carcass. The aim of this step is both to fix the layer of raw rubber to each of the sidewalls of the green tire carcass and to trap a bead wire, intended to improve the mechanical properties of the tire.

A unit comprising a shaft, a holder mounted in a sliding manner with respect to the shaft, arms connected to the holder in an articulated manner, and guide means, fastened to the shaft, for guiding the free ends of the arms, is known.

Such a unit operates in the following way. The green tire carcass is fitted on the shaft. The layer of rubber initially has a cylindrical configuration and covers the arms applied along the shaft, parallel to one another. Driving means, formed for example by a pneumatic cylinder fastened to the shaft and inside the latter, slide the holder, and thus also the arms, in the direction of the green tire. The arms drive the layer of rubber, which thus starts a turn-up. When the free ends of the arms come into contact with the guide means, the latter force the arms to rotate with respect to the holder in order to slide the arms along the sidewalls of the green tire in order to apply the layer of raw rubber. In particular, the rotation of the arms is controlled by the sliding of the holder by virtue of the guide means.

Such a unit has a number of drawbacks.

Specifically, the arms are driven in translation and rotation by the pneumatic cylinder. As a result, the application pressure is broken down into an application force for the product and a force for rotating the arms. Since the rotary component is weak when the arms are in a low position, an application force much greater than required by the product is necessary for rotating the arms in order to lift them. This can impair the proper fixing thereof to the green tire, since the application of an excessive pressure to the layer of rubber has the effect of laminating and thus damaging the latter. Moreover, if the green tire and the sidewalls are held in position by an inflatable bladder, the application of a force to the sidewalls by the arms can result in deformation of the sidewalls towards the interior of the green tire. This has the effect of modifying the pressure applied during ply turning. Since a pneumatic cylinder does not make it possible to take the deformations of the sidewalls of the tire into account, the quality of ply turning is reduced.

### SUMMARY OF THE INVENTION

An aim of the invention is to improve the quality of turning up the plies of a green tire.

To this end, a method for turning up the plies of a green tire is provided according to the disclosure, wherein longitudinal and radial movements, with reference to a main axis of the green tire, of ply-turning arms are brought about independently of one another in order to apply a rubber element to at least one sidewall of the green tire, wherein the radial movement of the arms is controlled by means of a speed setpoint.

Thus, by virtue of the control of the longitudinal and radial movements, independently of one another, when a speed setpoint is applied to the radial movement, it is possible to control the movement of the arms such that they apply to the layer of rubber, in the correct position along the sidewall of the tire, a force of predetermined strength allowing proper fixing of the layer of rubber to the sidewall. In this way, the quality of the tire produced and the reproducibility of ply turning are improved.

Moreover, the control of the movement of the arms by means of the speed setpoint makes it possible to control the speed of the arms throughout ply turning. This helps to improve the reproducibility of ply turning.

According to a first embodiment of the disclosure, a speed is applied to the radial movement and a force is applied to the longitudinal movement.

This first embodiment makes it possible to obtain better quality of ply turning and excellent control of the application force.

According to a second embodiment of the disclosure, a speed is applied to the longitudinal movement of the arms and a speed is applied to the radial movement of the arms.

This second embodiment has the advantage of being easy to implement but with less control of the application force.

This further improves the reproducibility of ply turning. This also makes it possible to better adapt the force setpoint to the position of the arms, since it is known at every point on the trajectory of the arms.

Advantageously, the radial movement of the arms is brought about by rotating them with respect to the green tire.

The radial movement of the arms can thus be realized by simple means.

Advantageously, the movement of the arms is stopped at a predetermined position and a predetermined force is applied to the green tire.

Such a control protocol comprising movements of the arms followed by pauses for pressing the layer of rubber improves the adhesion thereof to the green tire.

Advantageously, each arm is moved such that, in a portion of the trajectory of the arm, the arm has a movement component that moves it away from an equatorial plane of the green tire.

It is thus possible to adapt the method to the turning up of the plies of a green tire having what is known as an “omega” profile, that is to say one having a relief on each of its two sidewalls which forces some of the arms to move back partially when they pass through the corresponding section of the green tire during ply turning.

Also provided according to the disclosure is a unit for turning up the plies of green tires, which comprises:
a base for receiving a green tire,
ply-turning arms,
means for driving the arms longitudinally with respect to the green tire parallel to a main axis of the green tire,
means for driving the arms radially with respect to the green tire, and
a control member that is able to control the longitudinal driving means and the radial driving means independently of one another by means of a speed setpoint.

Advantageously, the longitudinal driving means and the radial driving means comprise electric actuators.

The electric actuators allow better control, thereby making it more easily possible to control the position of the arms and the pressure that they apply to the layer of rubber at all times.

### BRIEF DESCRIPTION OF THE DRAWINGS

Several embodiments of the disclosure will now be described with reference to the appended drawings, in which

FIGS. 1 and 2 are perspective views of a unit for turning up the plies of green tires according to the disclosure,

FIGS. 3 and 4 are views in longitudinal section of the unit in FIG. 1 in different configurations,

FIG. 5 is a perspective view of the unit in FIG. 1 at a different angle,

FIGS. 6 to 8 are views in longitudinal section of the unit in FIG. 1 in different configurations,

FIGS. 9 and 10 are graphical depictions of two trajectories of the arms that are allowed by the unit in FIG. 1,

FIG. 11 illustrates the movement of the arms along a sidewall of the green tire,

FIG. 12 is a diagram illustrating the ply-turning method carried out by means of the unit in FIG. 1,

FIG. 13 shows the change in the positions of the arms over time during the implementation of a ply-turning method according to a second embodiment of the disclosure,

FIGS. 14 and 15 show the change in the positions of the arms over time during the implementation of a ply-turning method according to a first embodiment of the disclosure, for a conventional green tire and for an “omega” tire, respectively,

FIG. 16 is a view in longitudinal section of a unit according to a variant embodiment of the disclosure,

FIG. 17 is a perspective view of the unit in FIG. 16,

FIGS. 18 to 20 illustrate sliding of a base of the unit in FIG. 16,

FIGS. 21 to 23 illustrate sliding of a main connecting member of the unit in FIG. 16, and

FIGS. 24 to 26 illustrate sliding of a secondary connecting member of the unit in FIG. 16.

### DETAILED DESCRIPTION OF THE DRAWINGS

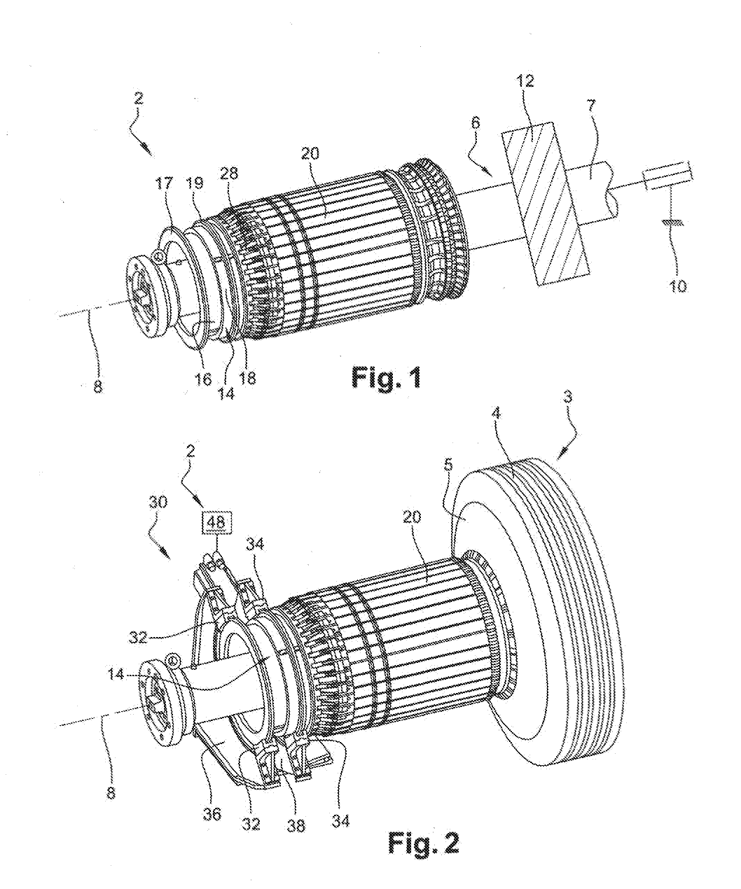

FIGS. 1 and 2 illustrate a unit 2 for turning up the plies of green tires according to the disclosure. This unit 2 is intended to turn up the plies of an unvulcanized green tire 3 provided with a crown 4 having an overall shape similar to that of a cylinder and two sidewalls 5 that are situated on either side of the crown 4 and extend opposite one another, from the crown 4 in the direction of a main axis of the green tire 3. The unit 2 is suitable for turning up the plies of any type of tire.

The unit 2 comprises a base 6 for receiving a green tire. This receiving base 6 comprises a shaft 7, in this case of cylindrical overall shape, having a main axis 8. The shaft 7 is mounted so as to be rotatable about the axis 8 with respect to a stand 10 of the unit 2. The shaft 7 has, on its external face, a mount 12 that is illustrated schematically in FIG. 1 and is intended to hold the green tire 3 in order to have its plies turned up. The receiving base 6 is part of a cylindrical drum of axis 8 for the building of a green tire by successively depositing different elastomer-based layers, which are or are not reinforced, and the annular elements of the bead. Such a drum comprises radially extendable circumferential receiving grooves intended to receive the beads of a green tire carcass and elements of the generally known type for shaping the latter.

The following elements are located on one side of the mount 12. Similar and symmetric elements are located on the other side and will not be described.

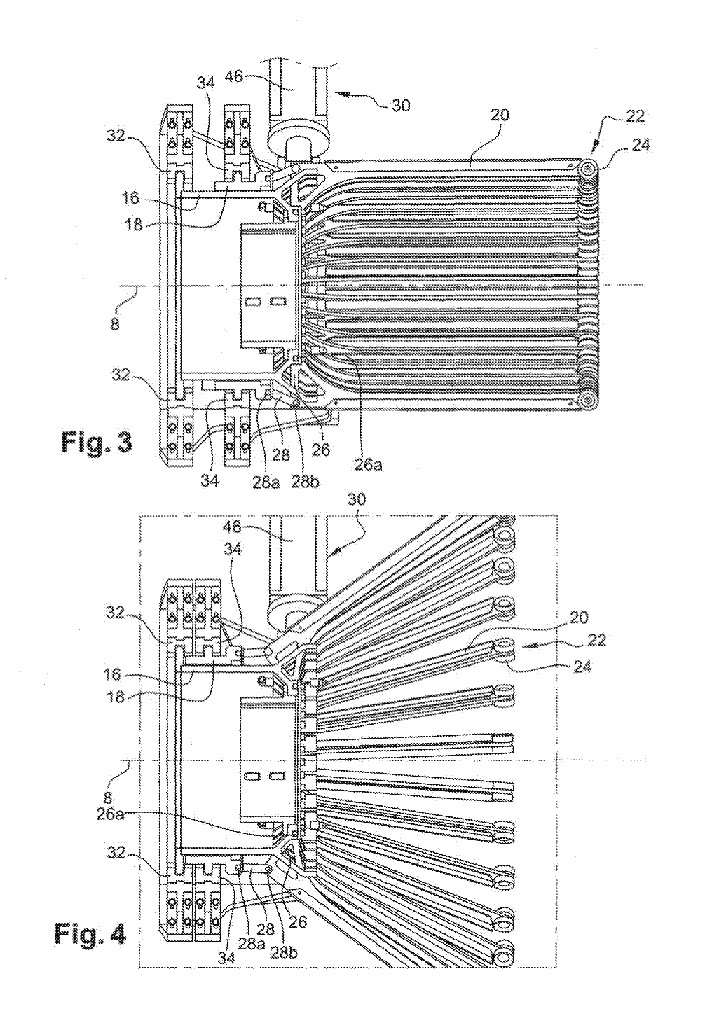

The unit 2 comprises a holder 14 mounted in a sliding manner with respect to the shaft 7, coaxially with and on the latter. The holder 14 is illustrated notably in FIGS. 3 and 4.

The holder 14 in this case comprises a first connecting member 16, referred to as main connecting member, mounted in a sliding manner with respect to the shaft 7, coaxially with and on the latter.

An annular rib, referred to as main rib 17, protrudes radially from an external face of the main connecting member 16 around the entire circumference thereof.

The holder 14 also comprises a second connecting member 18, referred to as secondary connecting member, mounted in a sliding manner with respect to the main connecting member 16, coaxially with and on the latter. The secondary connecting member 18 thus extends around the main connecting member 16, partially covering it. However, it has a length parallel to the axis 8 that is less than that of the main connecting member 16, such that the secondary connecting member 18 only partially covers the main connecting member 16, as can be seen notably in FIG. 3.

The main connecting member 16 and the secondary connecting member 18 are in this case each formed by a sleeve with an axis parallel to the axis 8. The main connecting member 16 will be designated by the expression “main sleeve” and the secondary connecting member 18 by the expression “secondary sleeve”.

An annular rib, referred to as secondary rib 19, protrudes radially from an external face of the secondary sleeve 18 around the entire circumference thereof. The secondary rib 19 is closer to the mount 12 than the main rib 17. The functions of the main rib 17 and secondary rib 19 will be shown in the following text.

The unit 2 comprises a plurality of rectilinear arms 20 connected in an articulated manner to the holder 14. Each arm 20 has a free end 22 intended to come into contact with a layer of raw rubber 23 in the form of a closed ring to be applied to the green tire 3. This free end 22 is provided here with a wheel 24 for pressing down the layer of raw rubber 23 during the application thereof to the sidewall 5 of the green tire 3.

Each arm 20 is mounted in a rotatable manner with respect to the holder 14. To this end, each arm 20 is in this case directly connected in an articulated manner to the holder 14 by a foot 26 of the arm, about the axis 26a, which extends in a direction perpendicular to a main part of the arm 20. Each arm 20 is also connected to the holder 14 by means of a link 28 directly connected in an articulated manner to the holder 14 and to the arm 20, about axes 28a and 28b, respectively. In this case, each arm 20 is directly connected in an articulated manner to the main sleeve 16 by the foot 26 of the arm 20 and, independently thereof, is connected to the secondary sleeve 18 by means of the link 28. The connection of the arms 20 to the sleeves 16, 18 in an articulated manner is visible notably in FIGS. 3 and 4.

Thus, when the secondary sleeve 18 slides with respect to the main sleeve 16, it drives the arms 20 in rotation by virtue of the feet 26 and the links 28. More specifically, when the secondary sleeve 18 moves away from the arms 20, it causes the arms 20 to lift, which move away from the axis 8.

The unit 2 comprises a motor-driven station 30 external to the base 6 and independent thereof.

The motor-driven station 30 comprises at least one first fork 32, known as main fork, that is able to cover and move the main rib 17 in the direction of the axis 8. It also comprises at least one second fork 34, known as secondary fork, that is able to cover and move the secondary rib 19 in the direction of the axis 8.

There are two main forks 32 in this case, which are carried by a first support plate 36 of the motor-driven station 30. Similarly, there are two secondary forks 34 in this case, which are carried by a second support plate 38 of the motor-driven station 30. The forks 32, 34 and the support plates 36, 38 are illustrated in FIG. 2. Provision can be made to provide each support plate 36, 38 with a number of forks greater than two in order to improve the gripping of the main rib 17 and secondary rib 19.

The support plates 36, 38 in this case each have the form of a sector of a ring extending in planes perpendicular to the axis 8 and through an angular range less than 180°. In this case, the sectors extend through an angular range of between 150° and 180°. In each ring sector, the two forks are positioned at free ends of the ring sectors. In this way, the forks are virtually diametrically opposite with respect to the axis 8, thereby making it possible to optimize the gripping of the main rib 17 and secondary rib 19.

The first support plate 36 is rigidly secured to the motor-driven station 30. The second support plate 38 is for its part mounted in a sliding manner with respect to the first support plate 36 parallel to the axis 8.

By virtue of the shape of the forks 32, 34 and of the ribs 17, 19, the motor-driven station 30 is able to slide the main sleeve 16 and the secondary sleeve 18 with respect to the stand 10 even when the shaft 7 is rotating. Specifically, the shape of the forks 32, 34 allows them not to prevent the rotation of the ribs 17, 19 and thus not to prevent that of the sleeves 16, 18. In other words, when the shaft 7 is rotating, the ribs 17, 19 slide in their respective forks 32, 34.

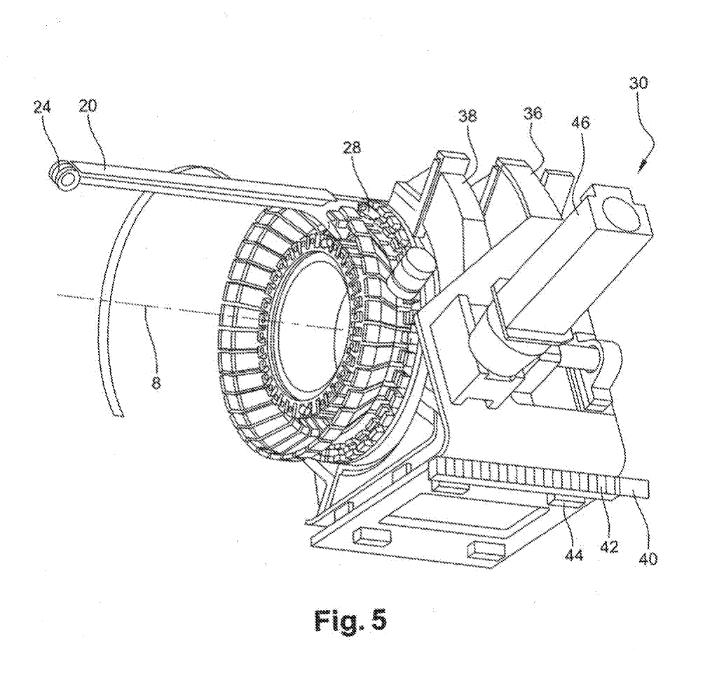

The motor-driven station 30 comprises pushing means that are able to slide the first support plate 36 parallel to the axis 8 with respect to the stand 10 and are able to slide the second support plate 38 parallel to the axis 8 with respect to the first support plate 36. As is illustrated in FIG. 5, it is a first electric motor 40, coupled to a rack 42 guided by shoes 44, which slides the first support plate 36, and it is a motor block 46, in this case comprising a second electric motor, a reduction gear and a screw-nut mechanism (these not being shown), which slides the second support plate 38.

The motor-driven station 30 is mounted so as to be movable between an active configuration, in which it is coupled to the arms 20 and the base 6, by means of the forks 32, 34, and a passive configuration, in which it is uncoupled from the arms 20 and the base 6. To this end, it comprises for example means for moving the plates 36, 38 away from or towards the arms 20 and the base 6.

The assembly comprising the receiving base 6, the holder 14 and the arms 20 forms a building drum that is able to cooperate with the motor-driven station 30 external to the drum.

The unit 2 comprises a control member 48 that is able to control the motor-driven station 30 to position the arms 20. The control member 48 in this case comprises a computer provided with a central processing unit. The latter contains a computer program comprising code instructions that are able to bring about the execution of a ply-turning method as described below. The computer program can be saved on a data storage medium that is readable by the central processing unit of the computer.

A ply-turning method implemented by the unit 2 will now be described. In order to simplify the presentation of this method, only the application of a layer of raw rubber to one of the two sidewalls 5 will be presented. The method is applied symmetrically in the same way to both sides of the green tire 3. Generally, ply turning is carried out on both sides of the green tire 3 simultaneously.

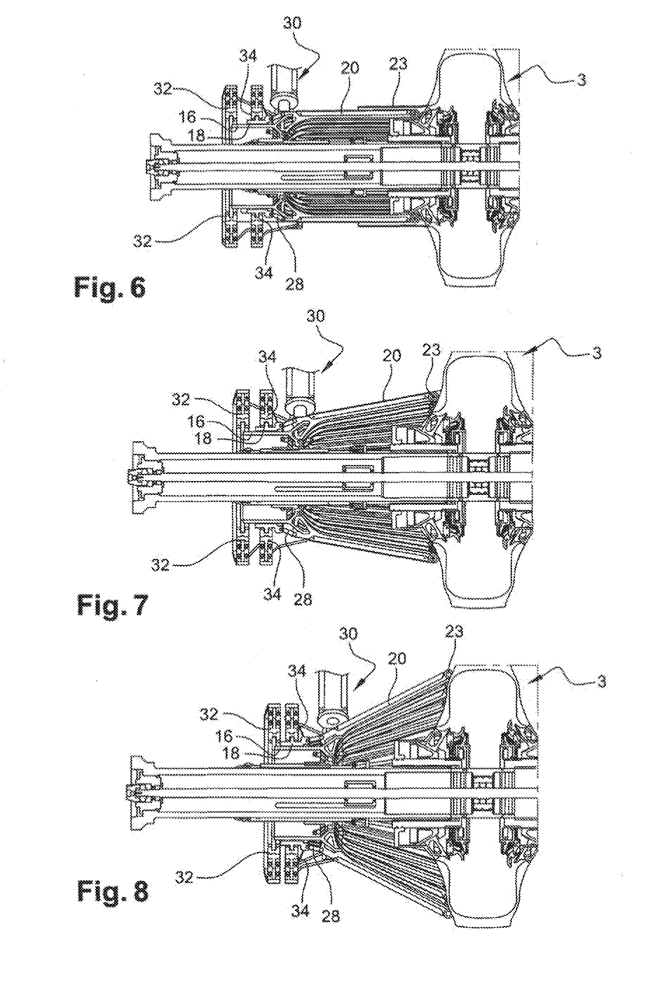

First of all, the green tire 3 is fitted on the mount 12 of the base 6. At this stage, it is a green tire carcass. Each arm 20 takes up an initial position in which the free end 22 of the arm 20 is spaced apart from the green tire 3. The arms 20 are in their configuration closest to the axis 8 and are parallel to the latter and to one another, as in FIG. 6, forming a cylinder.

The layer of rubber 23 in the form of a closed ring is placed on the arms 20 such that one end of this layer of rubber 23 faces the free ends 22 of the arms that it covers.

Next, the motor-driven station 30 of the receiving base 7 is approached and it is coupled to the holder 14. This involves placing the main rib 17 and secondary rib 19 in the main fork 32 and secondary fork 34, respectively. The motor-driven station 30 thus passes from the passive configuration to the active configuration.

In order to apply the layer of rubber 23 to the sidewall 5, the motor-driven station 30 is then slid with respect to the stand 10 in the direction of the green tire 3 and at the same time the second support plate 38 is slid in the direction of the first support plate 36, that is to say moving away from the green tire 3, by virtue of the above-described pushing means.

These two sliding movements are controlled by the control member 48. The latter thus controls the longitudinal and radial movements of the free end 22 of each arm 20. This is possible since the position of the free ends of the arms depends on the position of the first support plate 36 and second support plate 38. Specifically, by virtue of the feet 26 and the links 28, a movement of the second support plate 38 with respect to the first causes the arms 20 to rotate and sliding of the first support plate 36 in the direction of the green tire 3 causes the arms 20 to slide parallel to the axis 8.

These two sliding movements are also brought about by the control member 48 depending on a setpoint. In a first embodiment of the disclosure, of the longitudinal and radial movements of the arms 20, one of these movements is controlled in terms of speed and the other of these movements is controlled in terms of force. Advantageously, the choice is made to control the radial movement by means of a speed setpoint and to control the longitudinal movement by means of a force setpoint. Thus, for each arm 20, regardless of its position, the intensity of the force that it applies to the layer of rubber 23 and the sidewall 5 of the green tire 3 is controlled. It is thus possible to realize the radial movement of the arms at a given speed until they reach the desired position with respect to the green tire and then to stop the radial movement and continue only the axial movement until the pre-established force setpoint on the green tire is reached. Such a control protocol comprising movements of the arms followed by pauses for pressing the compounds against one another allows these rubber compounds to adhere better to one another at the sidewalls of the green tire. This ensures that the layer of rubber 23 is fixed optimally to the sidewall 5.

In a second embodiment of the disclosure, the longitudinal and radial movements of the arms 20 are controlled by means of a speed setpoint.

The configuration illustrated in FIG. 7 is thus adopted, in which the layer of rubber 23 has been partially applied to the sidewall 5 of the green tire 3. The first and second support plates 36, 38 thus form driving means for sliding and rotating the arms 20, respectively. It will also be understood that the rotation of the arms takes place independently of the sliding of the arms.

During this movement, the ends of the arms 20 travel over the sidewall 5 in the direction radial to the axis 8, in the direction away from the latter, that is to say in the direction of the crown 4 of the green tire 3, in the process applying the layer of rubber 23 to the sidewall 5.

By continuing the two sliding movements, the configuration illustrated in FIG. 8 is finally reached, in which the layer of rubber 23 completely covers the sidewall 5. The motor-driven station is thus uncoupled from the holder 14, this involving removing the ribs 17, 19 from the forks 32, 34, and it is moved apart from the receiving base 7. The motor-driven station 30 thus passes from the active configuration to the passive configuration, awaiting its next use.

By virtue of the fact that the motor-driven station 30 is external to the base 6 and independent thereof, the two sides of the unit 2, that is to say on either side of the mount 12, can be provided with two motor-driven stations that are controlled differently from one another. The unit 2 thus makes it possible to turn up the plies of green tires having different and asymmetric profiles.

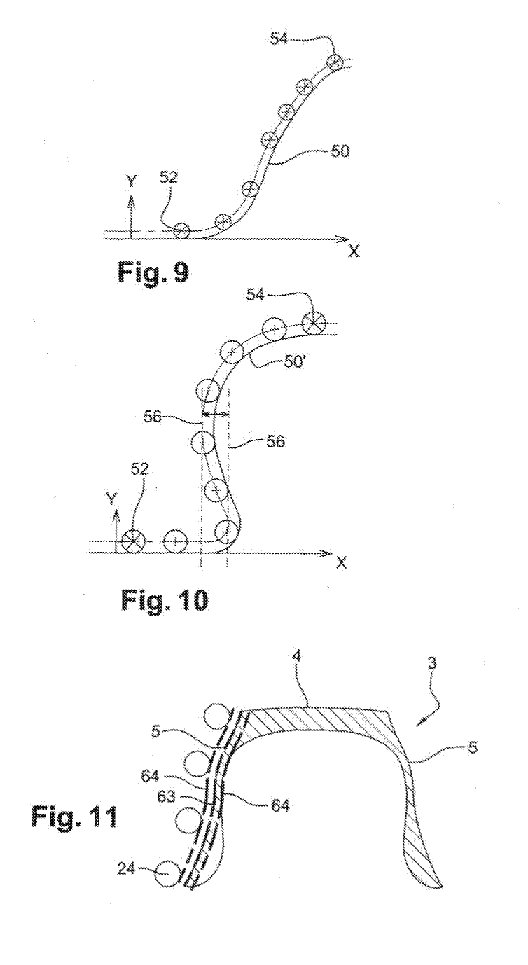

FIG. 9 illustrates a first example of a trajectory 50, following the change in the position of the free end 22 of an arm 20 in an orthogonal frame of reference, the origin of which is a point of the stand 10 and the axes X and Y of which are the main axis 8 and an axis radial to the axis 8, respectively. During the movement of the free end 22 of the arm 20, this end 22 moves forward constantly while it moves constantly away from the axis 8, the two movements being uniform, between an initial position 52 corresponding to the configuration illustrated in FIG. 5 and a final position 54 corresponding to the configuration illustrated in FIG. 7.

FIG. 10 illustrates a second example of a trajectory 50′. This differs from the first example in that, in a portion of the trajectory of the arm 20, the free end 22 thereof has a movement component that moves it away from an equatorial plane of the green tire 3, that is to say parallel to the main axis 8. This movement component corresponds to a movement backward of the main sleeve 16 parallel to the main axis 8. This portion is delimited by the two broken lines 56. In other words, during its movement, the free end 22 moves forward, then moves backward and then moves forward again along this axis 8. This takes place while the end 22 moves away from the axis 8 in a uniform manner. This trajectory 50′ is used when required by the type of green tire of which the plies are to be turned up, for example if it is an “omega” green tire.

FIG. 11 shows the movement of the wheel 24 of one of the arms 20 along one of the sidewalls 5 of the green tire. Particularly illustrated in this figure is the fact that, in practice, the wheel 24 does not exactly follow its predetermined theoretical trajectory, indicated by the broken line 63, but follows a trajectory included in the vicinity of this trajectory, in this case bordered by the broken lines 64. This is notably due to the fact that the green tire 3 is made of a flexible material which therefore deforms easily while being rollered by the wheels 24. Since the movement of the arms 20 is controlled depending on an intensity setpoint of the force applied by the arms 20 to the green tire, this relative imprecision of the actual position of the wheels 24 is overcome.

In the example described, electric actuators are used which allow easy and precise control of the force applied by way of the intensity absorbed by the electric motor, according to the formula C=k·I, where C is the torque produced by the motor in Nm, k is a constant and I is the intensity of the electrical current passing through the motor at A. Such electric actuators are suitable both for control by means of a speed setpoint and for control by means of a force setpoint.

In one variant, hydraulic or pneumatic cylinders are used instead of the electric actuators and the force applied is controlled by controlling the pressure applied by the piston of the cylinder, according to the formula P=F/S, where P is the pressure of the fluid, F is the force applied and S is the cross-sectional area of the piston.

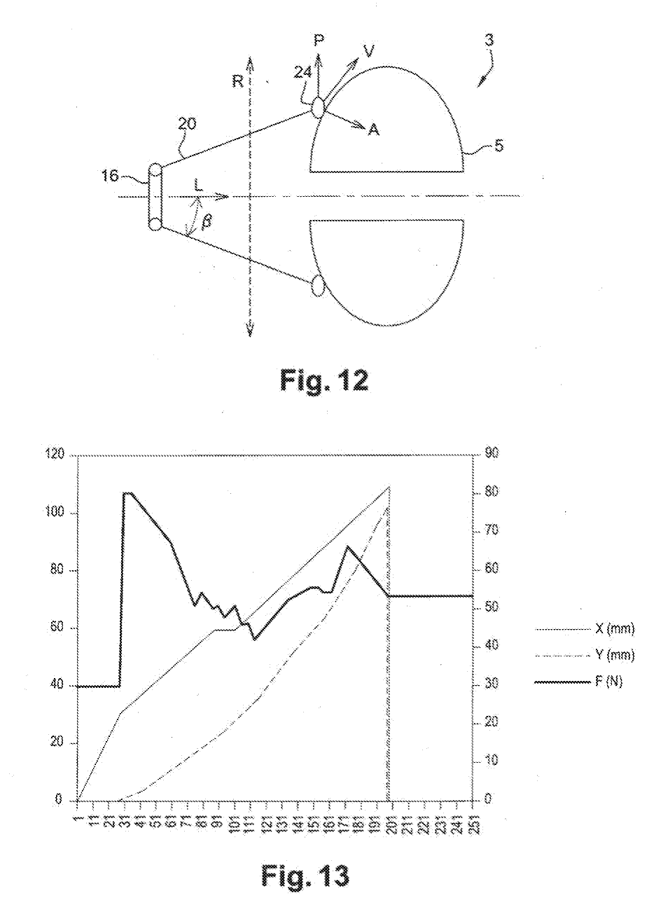

FIG. 12 illustrates in a simplified manner the implementation of the ply-turning method by means of the unit 2. Of the variables symbolized, L corresponds to the longitudinal movement of the arms 20, R corresponds to the radial movement of the arms 20, A corresponds to the normal application force of the wheels 24 to which the layer of rubber 23 is subjected during ply-turning, P corresponds to the force required to lift the layer of rubber 23, V is the speed of movement of the wheels 24 and _{R} is the angle formed between the arms 20 and the longitudinal axis.

FIG. 13 shows the change in the position of the arms 20, which follow a trajectory as illustrated in FIG. 9, over time during the implementation of the ply-turning method according to the second embodiment of the disclosure.

In the case of the second embodiment, the movements L and R are controlled by means of a speed setpoint. This makes it possible to define a trajectory of the wheels 24 corresponding to the setpoint by means of which the control member 48 effects the control. The application force A depends on the difference between the trajectory of the wheels 24 and the profile of the layer of rubber 23. If the latter does not correspond to the trajectory setpoint, the force will not be controlled. The force A also depends on the angle β, since the force will be greater at the start of ply turning than at the end of ply turning on account of the stiffness of the layer of rubber 23.

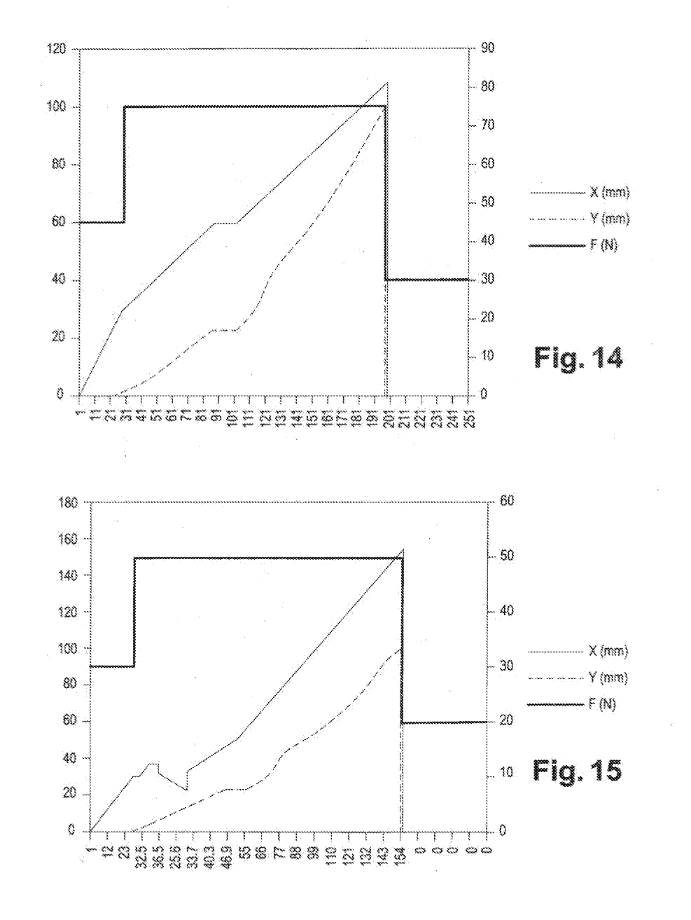

FIG. 14 shows the change in the position of the arms 20, which follow a trajectory as illustrated in FIG. 9, over time during the implementation of the ply-turning method according to the first embodiment of the disclosure. Of L and R, the first is controlled by means of a force setpoint and the second by means of a speed setpoint.

When it is R which is controlled in terms of speed, the longitudinal speed L is not controlled but depends on the radial speed R controlled.

It is also possible to make pauses and apply a well-controlled force to the green tire during lifting.

FIG. 15 is similar to FIG. 14, but differs therefrom in that the green tire 2 of which the plies are being turned up has an “omega” profile, as illustrated in FIG. 11. It can be seen that the wheel 24 moves forward along the longitudinal axis, then moves backward and then forward again. This takes place while the wheel 24 moves away from the longitudinal axis in a uniform manner.

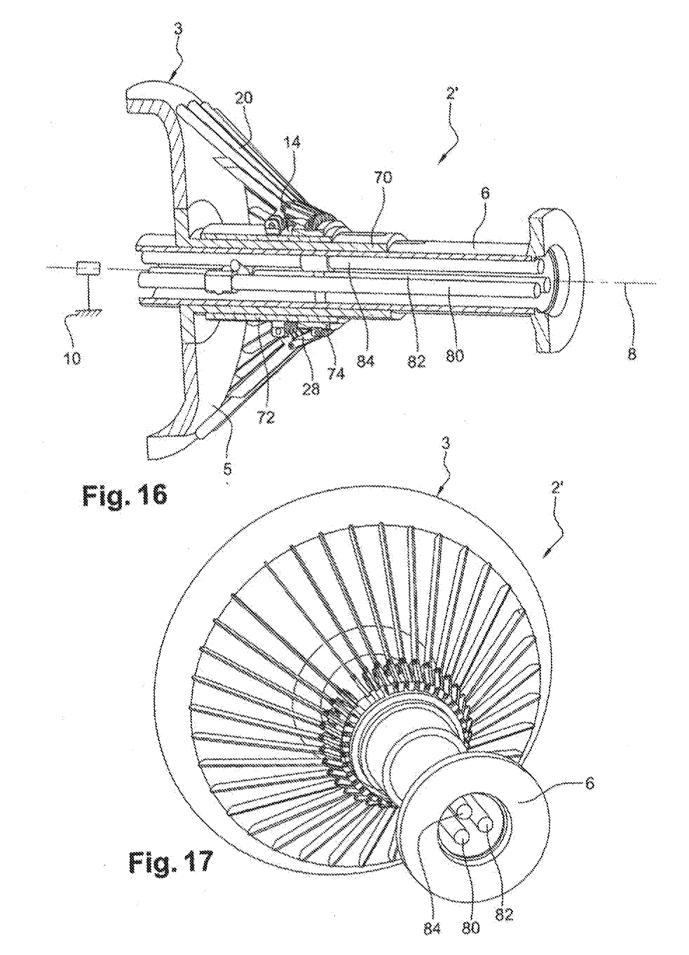

FIGS. 16 et seq. illustrate a ply-turning unit 2′ according to a variant embodiment of the disclosure. In the following text, mainly the elements which differ from the unit 2 presented above will be presented. As can be seen in FIGS. 16 and 17, the unit 2′ differs therefrom notably in that the driving means for sliding and rotating the arms 20, respectively, are housed inside the shaft 6. This makes it possible to reduce the space requirement of the unit.

The elements bearing the same reference numerals as above are identical, at least in terms of function.

The unit 2′ has a base 70, in this case in the form of a sleeve, mounted in a sliding manner on the shaft 6. One of the sidewalls 5 of the green tire 3 is fastened to the base 70. The holder 14 is mounted in a sliding manner on the base 70. The shaft 6 is for its part mounted so as to pivot with respect to a stand 10 of the unit 2′.

In a similar manner to the previous embodiments, the holder 14 comprises a main connecting member 72 mounted in a sliding manner with respect to the base 70 parallel to the main axis 8.

The holder 14 also comprises a secondary connecting member 74 mounted in a sliding manner with respect to the main connecting member 72 parallel to the axis 8.

The ply-turning arms 20 are mounted in a pivoting manner on the main connecting member 72. They are also connected to the secondary connecting member 74 by means of links 28.

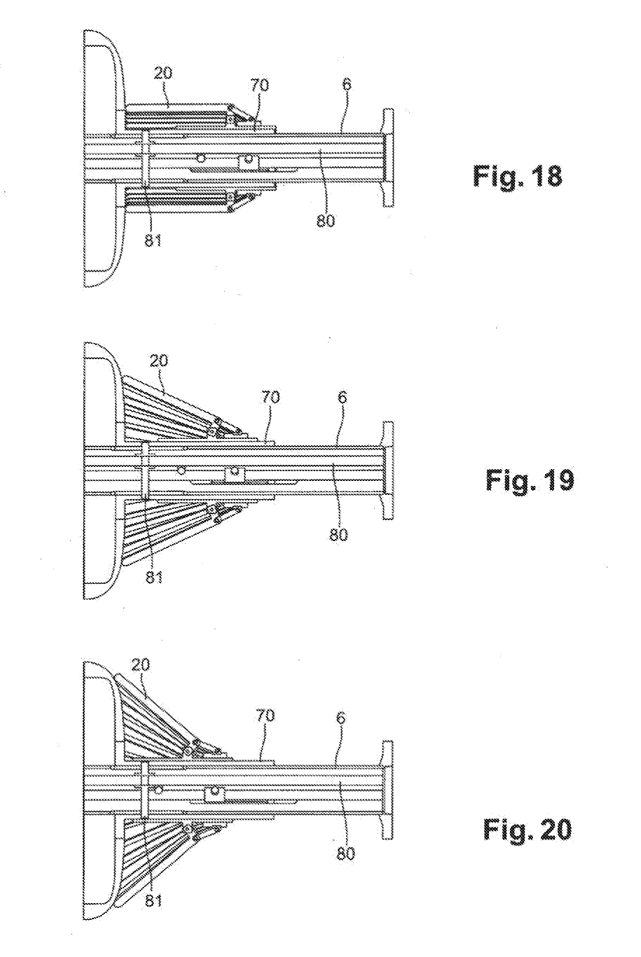

With reference to FIGS. 18 to 20, the unit 2′ has first driving means 80 that are able to slide the base 70 parallel to the axis 8 with respect to the shaft 6. These driving means 80 are situated inside the shaft 6.

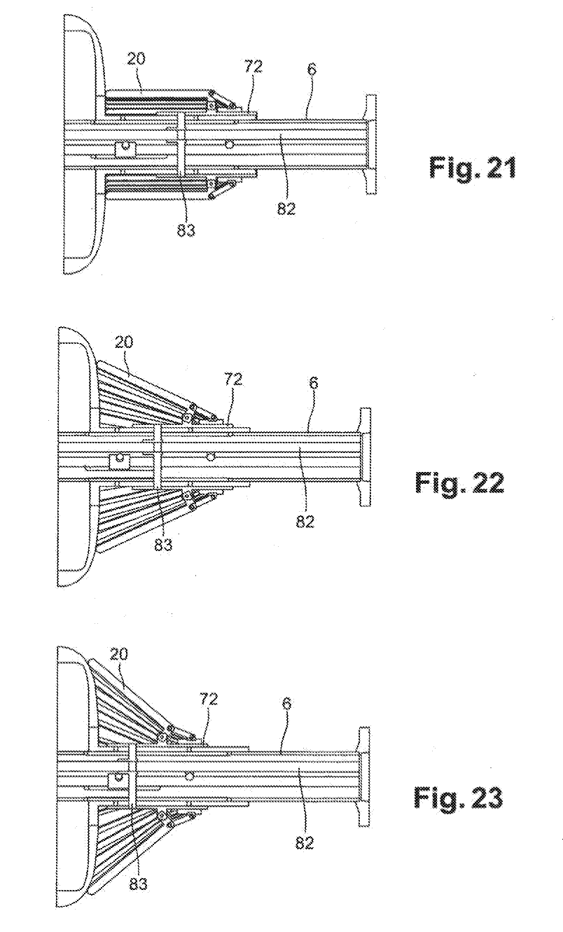

With reference to FIGS. 21 to 23, the unit 2′ has second driving means 82 that are able to slide the main connecting member 72 parallel to the axis 8 with respect to the shaft 6. This has the effect of sliding the ply-turning arms 20 parallel to the axis 8 in order to move them towards or away from the green tire 3.

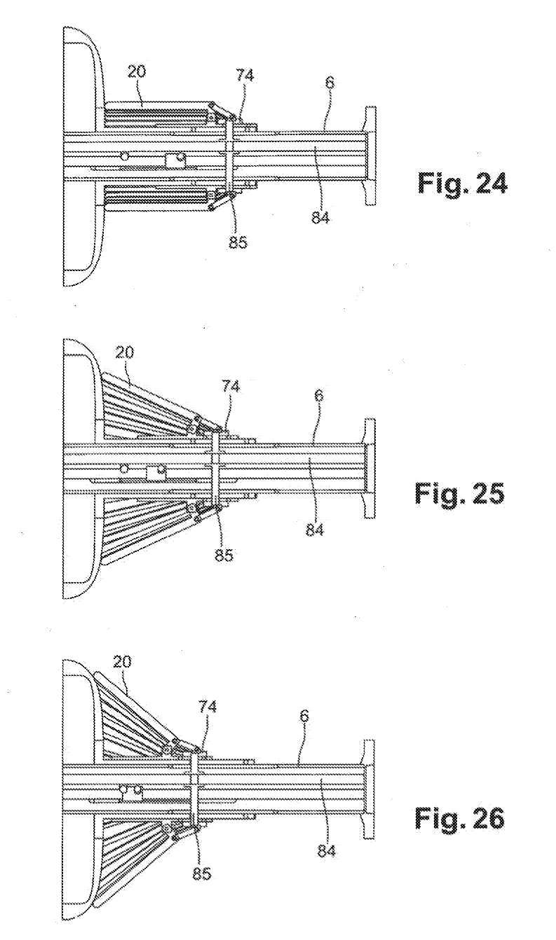

With reference to FIGS. 24 to 26, the unit has third driving means 84 that are able to slide the secondary connecting member 74 parallel to the axis 8 with respect to the shaft 6. This has the effect of rotating the ply-turning arms 20 by virtue of the links 28, in order to move them towards or away from the shaft 6.

The driving means 80, 82, 84 are secured to the base 70, to the main connecting member 72 and to the secondary connecting member 74, respectively, by means of rods 81, 83, 85 that extend through holes in the shaft 6, one of which is visible in FIG. 17. As is visible in FIG. 16, the rods are arranged such that they do not impede the respective movements thereof.

In this case, the driving means 80, 82 and 84 are each formed by a screw-nut mechanism. The latter are coupled to motors (not shown) positioned on the stand 10 or, in one variant, inside the shaft 6. The motors are independent of one another.

It is conceivable for the shaft 6 to be driven in rotation at the same time as the plies are turned up by positioning rotary seals at the electrical connectors for supplying power to the motors.

Of course, numerous modifications could be made to the disclosure without departing from the scope thereof. Thus, in one variant, the actuators can be inside the drum.

1. A method for turning up the plies of a green tire, said method comprising the step of:
with reference to a main axis of the green tire, longitudinally and radially moving ply-turning arms independently of one another to apply a rubber element to at least one sidewall of the green tire, wherein the radial movement of the arms is controlled by means of a speed setpoint.

2. The method according to claim 1, wherein a speed is applied to the radial movement and a force is applied to the longitudinal movement.

3. The method according to claim 1, wherein a speed is applied to the longitudinal movement and a speed is applied to the radial movement.

4. The method according to claim 1, wherein the radial movement of the arms is brought about by rotating the arms them with respect to the green tire.

5. The method according to claim 1, wherein the movement of the arms is stopped and a predetermined force is applied to the green tire.

6. The method according to claim 1, wherein each arm is moved such that, in a portion of the trajectory of the arm, the arm has a movement component that moves it away from an equatorial plane of the green tire.

7. A unit for turning up the plies of green tires, comprising:
a base for receiving a green tire,
ply-turning arms,
a longitudinal arm mover configured to drive the arms longitudinally with respect to the green tire parallel to a main axis of the green tire,
a radial arm mover configured to drive the arms radially with respect to the green tire, and
a control member that is able to control the longitudinal arm mover and the radial arm mover independently of one another, wherein the radial movement of the arms is controlled by means of a speed setpoint.

8. The unit according to claim 1, wherein the longitudinal arm mover and the radial arm mover comprise electric actuators.
